(19) United States
(12) Patent Application Publication
(10) Pub. No.: US 2025/0238228 A1
(43) Pub. Date: Jul. 24, 2025

(54) SYSTEMS AND METHODS FOR OVERRIDING ALGORITHM EXECUTION AT RUNTIME

(71) Applicant: Kinaxis Inc., Ottawa (CA)

(72) Inventors: Matthew William PENNY, Ottawa (CA); Marin CREANGA, Ottawa (CA)

(73) Assignee: KINAXIS INC., Ottawa, ON (CA)

(21) Appl. No.: 18/986,099

(22) Filed: Dec. 18, 2024

Related U.S. Application Data
(60) Provisional application No. 63/611,335, filed on Dec. 18, 2023.

(51) Int. Cl. G06F 8/71

(52) U.S. Cl. CPC G06F 8/71

(57) ABSTRACT

A system and method for overriding an algorithm at runtime include providing an override algorithm mapped to a first algorithm to override the first algorithm in a database, the override algorithm configured to provide a return value in a memory location corresponding to a result node of the first algorithm; receiving a trigger event that causes the first algorithm to be utilized in a computation; in response to receiving the triggering event, utilizing the override algorithm in place of the first algorithm in the computation; and storing the return value from the override algorithm in the memory location that corresponds to the result node of the first algorithm.

### CROSS-REFERENCE TO RELATED APPLICATIONS

The present application claims priority to U.S. Provisional Patent Application No. 63/611,335, filed Dec. 18, 2023; the entirety of which is hereby incorporated by reference.

A database can have many unique features, one aspect being that algorithms can be written natively to a database server. Using native algorithms, which may also be referred to as default algorithms, in the database server can facilitate a faster runtime when accessing and storing data in the database, thereby improving performance as compared to an algorithm that is written and executed externally to the database and database server.

Writing and executing algorithms in a database server causes those algorithms to be static, meaning that the code (e.g., C, C++, etc.) does not change once it is deployed as a default algorithm to the database. Default algorithms may be configured to behave slightly differently than programmed or written to account for user preferences. However, it can become onerous and/or unscalable to add new configurations for each user or customer that requires the default algorithm to behave slightly differently in a way that is tailored to each user's or customer's needs. In addition, modifying default algorithms can be difficult when the algorithm is configured to interact with other algorithms, e.g., with multiple or cascading dependencies.

It is therefore desirable to be able to override a default algorithm such that the results of the override algorithm replace the results of the default algorithm. A benefit of this solution is that users or customers can implement specific configurations that meet their unique needs without changing the code of the default algorithm, while also maintaining the performance benefit of using a default algorithm in a database server.

### BRIEF SUMMARY

The details of one or more embodiments of the subject matter of this specification are set forth in the accompanying drawings and the description below. Other features, aspects, and advantages of the subject matter may become apparent from the description, the drawings, and the claims.

The present disclosure describes systems and methods for overriding the execution of an algorithm at runtime. More specifically, the present disclosure describes systems and methods of overriding a default algorithm, i.e., an algorithm that runs natively to the database and database server, with an override algorithm that may be stored external to the database server and database.

In some embodiments, an override algorithm is not written inside the database server and is not run or executed at the database server. The override algorithm can behave as an embedded algorithm because it is executed at a device that communicates with the database to receive data from, and return data to, the database server.

In the present disclosure, an override algorithm may be defined to override a first algorithm (i.e., a default algorithm). Defining the override algorithm may comprise defining the inputs of the override algorithm, defining any dependencies of the override algorithm, defining return values of the override algorithm, and defining which default algorithm the override algorithm overrides. The override algorithm is mapped to the first algorithm and configured to output its return value(s) to memory location(s) that corresponds to result node(s) of the first algorithm. At runtime, when the first algorithm is triggered for use in a computation (for example, by a query or algorithm) the override algorithm is utilized in the computation in place of the first algorithm, and the return value of the override algorithm is stored according to the mapping.

Mapping override algorithms to default algorithms may comprise: generating a list of override algorithms that override default algorithms of a database server; the override algorithms in the generated list are marked as unprocessed. An iterative process may be performed to process the override algorithms, which may include determining if there are any unprocessed override algorithms in the list, and if so, selecting an unprocessed override algorithm, marking the result field(s) of the corresponding default algorithm as unprocessed, determining if there are any unprocessed default algorithm fields, and if so, selecting an unprocessed default algorithm field, and determining if a default field maps to an overridden field. If the default field maps to an overridden field, then mapping the result of the override algorithm to the default field result and marking the default algorithm field as processed. If the default field does not map to an overridden field, then setting the default field to a static or default value and marking the default algorithm field as processed.

Triggering an overriding algorithm in the place of a default algorithm at runtime may comprise triggering a default algorithm (for example, by a query or an algorithm) and determining if the default algorithm is overridden. If the default algorithm is overridden, the triggering the override algorithm, mapping the override algorithm results to the default algorithm results, and returning the calculated result. If the default algorithm is not overridden, then triggering the default algorithm and returning the calculated result.

Similarly, when the cache containing the stored return values of the override algorithm requires invalidation, an action triggering invalidation of the default algorithm's cached output will instead trigger invalidation of the override algorithm's cached output.

In one aspect, a computer-implemented method is provided, that includes: providing, by a processor, an override algorithm mapped to a first algorithm to override the first algorithm in a database, the override algorithm configured to provide a return value in a memory location corresponding to a result node of the first algorithm; receiving, by the processor, a trigger event that causes the first algorithm to be utilized in a computation, in response to receiving the triggering event; utilizing, by the processor, the override algorithm in place of the first algorithm in the computation; and storing, by the processor, the return value from the override algorithm in the memory location that corresponds to the result node of the first algorithm.

The method may also include: wherein providing the override algorithm includes: providing, by the processor, a plurality of override algorithms, each of the plurality of override algorithms mapped to at least one default algorithm in a first plurality of default algorithms that includes the first algorithm; and wherein utilizing the override algorithm in place of the first algorithm in the computation includes: utilizing, by the processor, the override algorithm of the plurality of override algorithms that is mapped to the first algorithm.

The method may also include, wherein: providing the override algorithm mapped to the first algorithm further comprises: mapping, by the processor, the override algorithm to the first algorithm to override the first algorithm in the database: and wherein mapping the override algorithm to the first algorithm comprises: identifying, by the processor, in a list the plurality of override algorithms; flagging, by the processor, the plurality of override algorithms in the list as unprocessed; determining, by the processor, if any of the plurality of override algorithms in the list is flagged as unprocessed; selecting, by the processor, an unprocessed override algorithm; flagging; by the processor, the corresponding at least one default algorithm mapped to the override algorithm as overridden; flagging, by the processor, the result node of the first algorithm as unprocessed; determining, by the processor, whether the result node of any of the plurality of default algorithms is flagged as unprocessed; selecting, by the processor, an unprocessed result node; determining, by the processor, whether the unprocessed result node from any of the plurality of default algorithms is located in the memory location that corresponds to an override result node of any of the plurality of override algorithms; in response to determining the unprocessed result node from any of the plurality of default algorithms is located in the memory location that corresponds to the override result node of any of the plurality of override algorithms: mapping, by the processor, the unprocessed result node to the override result node; and flagging, by the processor, the unprocessed result node as processed.

The method may also include, wherein: when the unprocessed result node from any of the plurality of default algorithms is not located in the memory location that corresponds to override result node of any of the plurality of override algorithms, the method further comprises: assigning, by the processor, the unprocessed result node a static value; and flagging, by the processor, the unprocessed result node as processed. The static value may be a numeric value of 0, or an empty string, or a time variable of Unix Epoch.

The method may also further comprise: identifying, by the processor, a second plurality of default algorithms, wherein the second plurality of default algorithms are not overridden by the plurality of override algorithms; and storing, by the processor, a default return value from each of the second plurality of default algorithms in the memory location that corresponds to the result node of each of the second plurality of default algorithms.

The method may also include where the memory location is associated with a cache. Where the memory location is associated with a cache, the method may also include: receiving, by the processor, an invalidation trigger event that invalidates a default return value in the cache; and in response to receiving the invalidation triggering event: invalidating, by the processor, a return value of the override algorithm in place of the default return value. Other technical features may be readily apparent to one skilled in the art from the following figures, descriptions, and claims.

In one aspect, a system is provided, that includes: a processor; and a memory storing instructions that, when executed by the processor, configure the system to provide an override algorithm mapped to a first algorithm to override the first algorithm in a database, the override algorithm configured to provide a return value in a memory location corresponding to a result node of the first algorithm; receive a trigger event that causes the first algorithm to be utilized in a computation; in response to receiving the triggering event, utilize the override algorithm in place of the first algorithm in the computation; and store the return value from the override algorithm in the memory location that corresponds to the result node of the first algorithm.

The system may also be configured to: when providing the override algorithm, provide a plurality of override algorithms, each of the plurality of override algorithms mapped to at least one default algorithm in a first plurality of default algorithms that includes the first algorithm; and when utilizing the override algorithm in place of the first algorithm in the computation, the system may be further configured to: utilize the override algorithm of the plurality of override algorithms that is mapped to the first algorithm.

When providing the override algorithm, the system may be further configured to: provide a plurality of override algorithms, each of the plurality of override algorithms mapped to at least one default algorithm in a first plurality of default algorithms that includes the first algorithm; and when utilizing the override algorithm in place of the first algorithm in the computation, the system may be further configured to: utilize the override algorithm of the plurality of override algorithms that is mapped to the first algorithm.

When providing the override algorithm mapped to the first algorithm, the system may be further configured to: map the override algorithm to the first algorithm to override the first algorithm in the database by configuring the system to: identify in a list the plurality of override algorithms; flag the plurality of override algorithms in the list as unprocessed; determine if any of the plurality of override algorithms in the list is flagged as unprocessed; select an unprocessed override algorithm; flag the corresponding at least one default algorithm to the override algorithm as overridden; flag the result node of the first algorithm as unprocessed; determine whether the result node of any of the plurality of default algorithms is flagged as unprocessed; select an unprocessed result node; determine whether the unprocessed result node from any of the plurality of default algorithms is located in the memory location that corresponds to an override result node of any of the plurality of override algorithms; and in response to determining the unprocessed result node from any of the plurality of default algorithms is located in the memory location that corresponds to the override result node of any of the plurality of override algorithms, the system may be configured to: map the unprocessed result node to the override result node; and flag the unprocessed result node as processed.

When the unprocessed result node from any of the plurality of default algorithms is not located in the memory location that corresponds to the override result node of any of the plurality of override algorithms, the system may be further configured to: assign the unprocessed result node a static value; and flag the unprocessed result node as processed. The static value may be a numeric value of 0, or an empty string, or a time variable of Unix Epoch.

The system of may be further configured to: identify a second plurality of default algorithms, wherein the second plurality of default algorithms are not overridden by the plurality of override algorithms; and store a default return value from each of the second plurality of default algorithms in the memory location that corresponds to the result node of each of the second plurality of default algorithms.

The system may also include where the memory location is associated with a cache. Where the memory location is associated with a cache. The system may be further configured to: receive an invalidation trigger event that invalidates a default return value in the cache; and in response to receiving the invalidation triggering event, invalidate a return value of the override algorithm in place of the default return value. Other technical features may be readily apparent to one skilled in the art from the following figures, descriptions, and claims.

In one aspect, a non-transitory computer-readable storage medium, the computer-readable storage medium including instructions that when executed by a computer, cause the computer to: provide an override algorithm mapped to a first algorithm to override the first algorithm in a database, the override algorithm configured to provide a return value in a memory location corresponding to a result node of the first algorithm; receive a trigger event that causes the first algorithm to be utilized in a computation, in response to receiving the triggering event; utilize the override algorithm in place of the first algorithm in the computation; and store the return value from the override algorithm in the memory location that corresponds to the result node of the first algorithm.

The non-transitory computer-readable storage medium may also further configure the computer to: when providing the override algorithm, provide a plurality of override algorithms, each of the plurality of override algorithms mapped to at least one default algorithm in a first plurality of default algorithms that includes the first algorithm; and when utilizing the override algorithm in place of the first algorithm in the computation, utilize the override algorithm of the plurality of override algorithms that is mapped to the first algorithm.

When providing the override algorithm mapped to the first algorithm, the computer may be further configured to: map the override algorithm to the first algorithm to override the first algorithm in the database by configuring the computer to: identify in a list the plurality of override algorithms; flag the plurality of override algorithms in the list as unprocessed; determine if any of the plurality of override algorithms in the list is flagged as unprocessed; select an unprocessed override algorithm; flag the corresponding at least one default algorithm to the override algorithm as overridden; flag the result node of the first algorithm as unprocessed; determine whether the result node of any of the plurality of default algorithms is flagged as unprocessed; select an unprocessed result node; determine whether the unprocessed result node from any of the plurality of default algorithms is located in the memory location that corresponds to an override result node of any of the plurality of override algorithms; and in response to determining the unprocessed result node from any of the plurality of default algorithms is located in the memory location that corresponds to the override result node of any of the plurality of override algorithms: map the unprocessed result node to the override result node; and flag the unprocessed result node as processed.

When the unprocessed result node from any of the plurality of default algorithms is not located in the memory location that corresponds to the override result node of any of the plurality of override algorithms, the computer may be further configured to: assign the unprocessed result node a static value; and flag the unprocessed result node as processed. The static value may be a numeric value of 0, or an empty string, or a time variable of Unix Epoch.

In the non-transitory computer-readable storage medium, the computer may be further configured to: identify a second plurality of default algorithms, wherein the second plurality of default algorithms are not overridden by the plurality of override algorithms; and store a default return value from each of the second plurality of default algorithms in the memory location that corresponds to the result node of each of the second plurality of default algorithms.

The non-transitory computer-readable storage medium may also include where the memory location is associated with a cache. Where the memory location is associated with a cache, the computer may be further configured to: receive an invalidation trigger event that invalidates a default return value in the cache; and in response to receiving the invalidation triggering event, invalidate a return value of the override algorithm in place of the default return value. Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for overriding algorithm execution at runtime in accordance with one embodiment.

FIG. 2 illustrates a block diagram of an example method for overriding algorithm execution at runtime in accordance with one embodiment.

FIG. 3 illustrates a block diagram of an example of a particular method for overriding a default algorithm with an override algorithm in accordance with the embodiment illustrated in FIG. 2.

FIG. 4 illustrates a block diagram of an example method for mapping default algorithms overridden by an override algorithm at runtime in accordance with one embodiment.

FIG. 5 illustrates a block diagram of an example method for triggering an override algorithm in place of a default algorithm at runtime, in accordance with one embodiment.

FIG. 6A illustrates example return values of an example first algorithm or a default algorithm.

FIG. 6B illustrates example return values of an example override algorithm that is configured to override the example default algorithm of FIG. 6A in accordance with embodiments of the present disclosure.

FIG. 7 illustrates a block diagram of an example method for defining an override algorithm, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

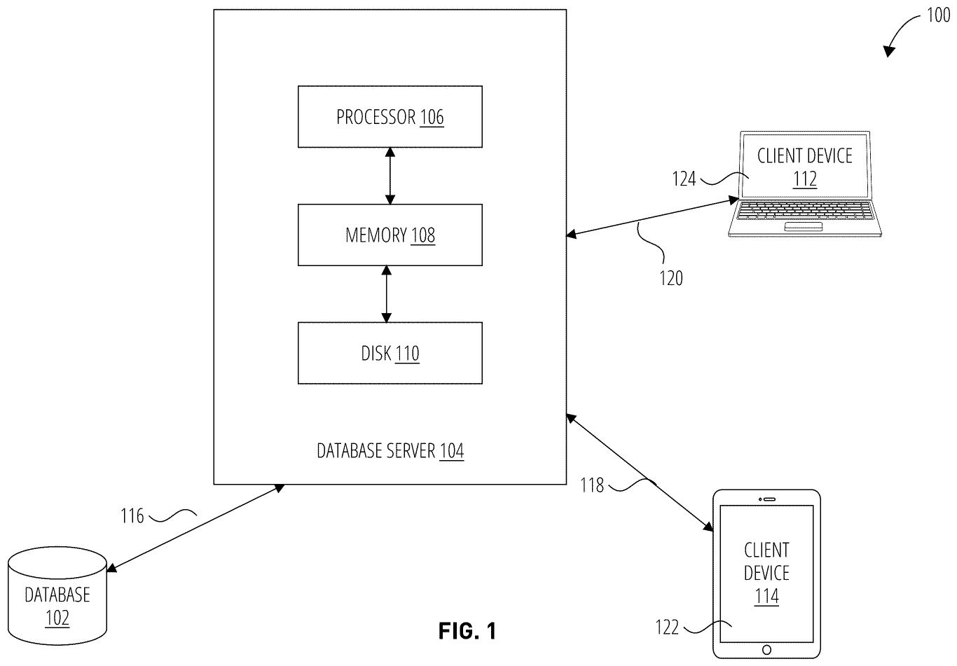

FIG. 1 illustrates an example of a system 100 for overriding algorithm execution at runtime.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

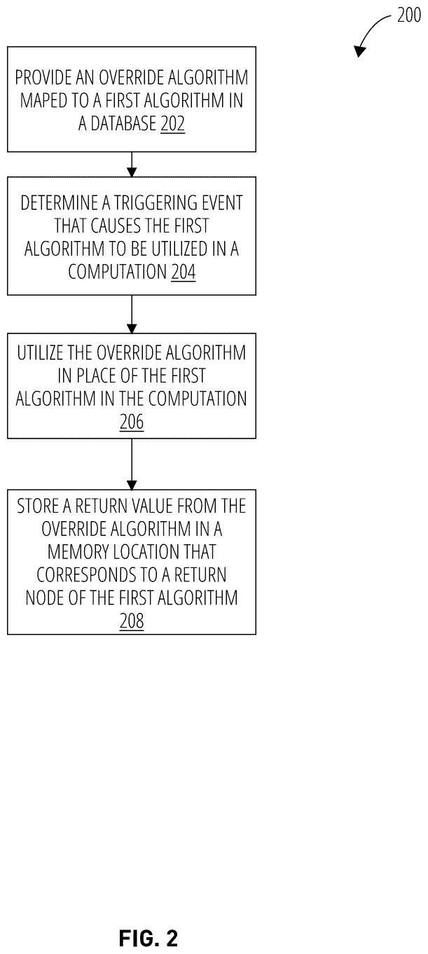

FIG. 2 illustrates a block diagram 200 of an example method for overriding algorithm execution at runtime in accordance with one embodiment. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At block 202, an override algorithm is provided that overrides a first algorithm in a database, the override algorithm being mapped to the first algorithm in the database. The override algorithm may comprise code that is stored and executed external to the database server 104. For example, the override algorithm may be executed by an external device that communicates with the database server 104 to receive data from and return data to the database server 104. In other embodiments, the override algorithm may be provided by the database server receiving the override algorithm from an external device, such as a client device (for example, client device 112 and/or client device 114).

The first algorithm may comprise an algorithm in the database server 104 such as, for example, a native or default algorithm that is stored at, for example, the memory 108 of the database server 104 of the database 102 in communication with the database server 104, and is executed at the database server 104.

In the present disclosure, to “run” or “execute” an algorithm means that the algorithm is utilized in a computation being performed on data stored in a database, such as the database 102.

In an embodiment, a plurality of override algorithms are provided at block 202 that are each mapped to a respective one of a plurality of default algorithms of a database server 104, wherein the plurality of default algorithms includes the first algorithm. In a further embodiment, each override algorithm maps to a default algorithm. Embodiments of the present disclosure may include different mapping configurations in the database, such as override algorithms mapping to more than one default algorithm. Similarly, some default algorithms may not be overridden while other default algorithms are overridden.

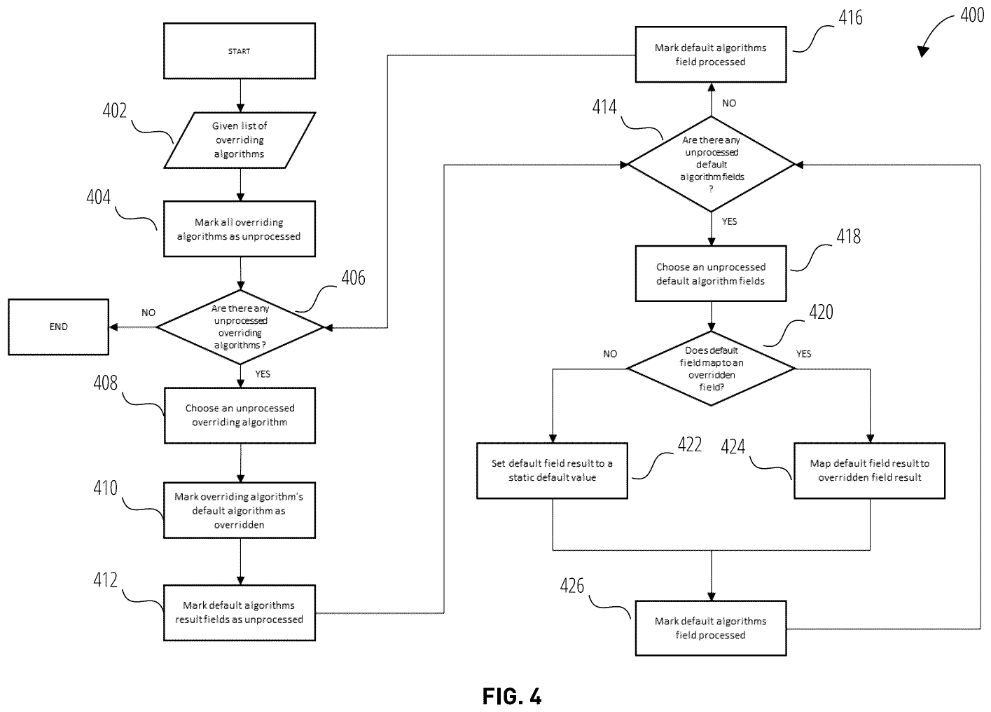

Providing the override algorithm at block 202 may include, for example, receiving at the database server 104, a list of override algorithms, as described in more detail below with reference to FIG. 4. This list may be included with the override algorithms in the case in which override algorithms are received at the database server 104, or the list may be received without the override algorithms in the case in which the override algorithms are stored and executed at a device external to the database server 104.

At block 204, during runtime, a triggering event is determined that signals that the first algorithm should be executed or used in a computation. Runtime may comprise executing, for example, a schema, process, subroutine, or computation in the database server 104 that utilizes one or more algorithms. In embodiments of the invention, the triggering event may be a query, another algorithm, or the first algorithm itself, that would typically result in the first algorithm being utilized in a computation performed by, for example, the database server 104. At runtime, any number of default algorithms in the database may be utilized for a computation, and not all default algorithms in a database may be utilized for a particular computation.

At block 206, in response to the triggering event, the override algorithm is used in place of the first algorithm in the computation being performed during runtime. Using the override algorithm at block 206 may include, for example, determining that the override algorithm is mapped to the first algorithm and returning return value(s) of the override algorithm in the place of default return value(s) of the first algorithm.

At block 208, the return value from the override algorithm is stored in the memory location that corresponds to a result node of the first algorithm. A return value may comprise any format, including but not limited to, JSON, XML, or Binary format. The memory location may comprise any location, including but not limited to, in memory, disk storage, or another database. The memory location may be in, for example, the memory 108 or the disk 110 of the database server 104 or the database 102 in communication with the database server 104 in the example system 100 described previously with reference to FIG. 1. A result node may comprise any memory location assigned to or otherwise corresponding to the default return value(s) of the first algorithm.

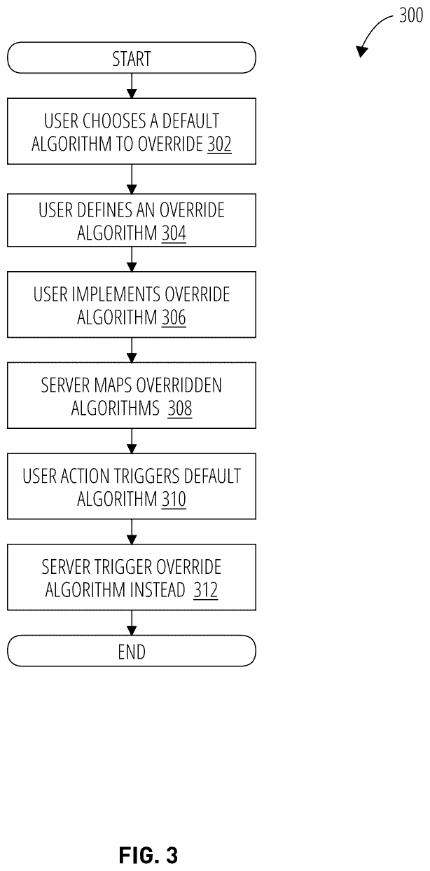

FIG. 3 illustrates a block diagram 300 of an example of a method for overriding a default algorithm with an override algorithm in accordance with the embodiment illustrated in FIG. 2. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At block 302, a first algorithm to override is selected. The first algorithm may be a default algorithm of, for example, the database server 104 described previously with reference to FIG. 1. The first algorithm may be selected by, for example, a user, such as a user of the database server 104 of FIG. 1. As an example, selecting a first algorithm may include a customer indicating to the database server 104 that the customer seeks a different computation or result from the algorithm, or a different result or computation of the schema or process in which the algorithm is run on the database server 104. In another example, selecting a first algorithm may include a customer, user, or service provider selecting the first algorithm to be overridden for any conceivable purpose at any stage in the development, deployment, and/or use of the algorithm in the database 102. Selecting the first algorithm may be performed via an external device such as, for example, the example client devices 112, 114 in communication with the database server 104 in the example system 100 described with reference to FIG. 1.

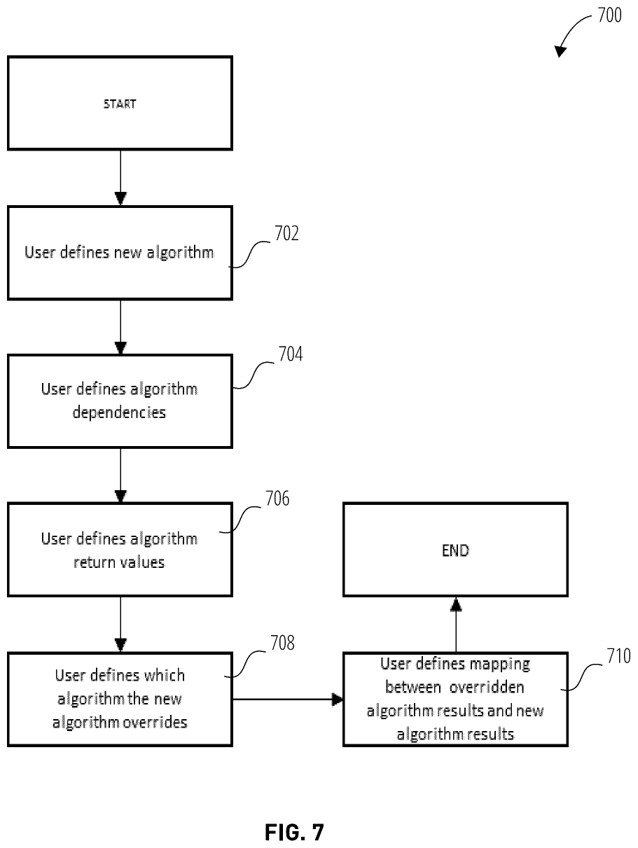

At block 304, an override algorithm is defined. The override algorithm may be defined by, for example, a user such as, for example, a user of the system 100 described previously with reference to FIG. 1. Defining the override algorithm may include defining return values of the override algorithm, defining inputs to the override algorithm, defining any dependent algorithms of the override algorithm, defining which first algorithm the override algorithm overrides, and/or configuring the mapping between the override algorithm return values and the first algorithm return values. Defining the override algorithm may comprise defining the override program utilizing a subroutine. An example subroutine is illustrated in FIG. 7.

At block 306, the user implements an override algorithm to override the default algorithm. Implementing the override algorithm may comprise any method of causing the override algorithm to be utilized in place of the first algorithm when the first algorithm is triggered, which results in producing an output or result, for example the return values defined at block 304. Implementing the override algorithm may include, for example, causing the override algorithm to be provided at block 202, as described previously with reference to FIG. 2, or may include generating a list of override algorithms as will be described in more detail with reference to FIG. 4.

At block 308, a database server, such as the database server 104 described previously with reference to FIG. 1, maps an output of the override algorithm to a memory location that corresponds to a result node of the first algorithm. The result node of the first algorithm may be, for example, a memory location of the memory 108 or the disk 110 of the database server 104 of the database 102 in the example system 100 described previously with reference to FIG. 1. In an embodiment, the example method described later with reference to FIG. 4 may be used to implement the mapping at block 308. The output of the override algorithm may comprise one or more return values, each of which correspond to a result node of the default algorithm.

At block 310, during runtime, the default algorithm is triggered. Runtime may comprise executing, for example, a schema, process, subroutine, or computation by the database server 104 utilizing at least one algorithm. A default algorithm may be triggered by a query, by another algorithm, or by the default algorithm itself during the runtime. Such triggers may occur due to a user action or other means.

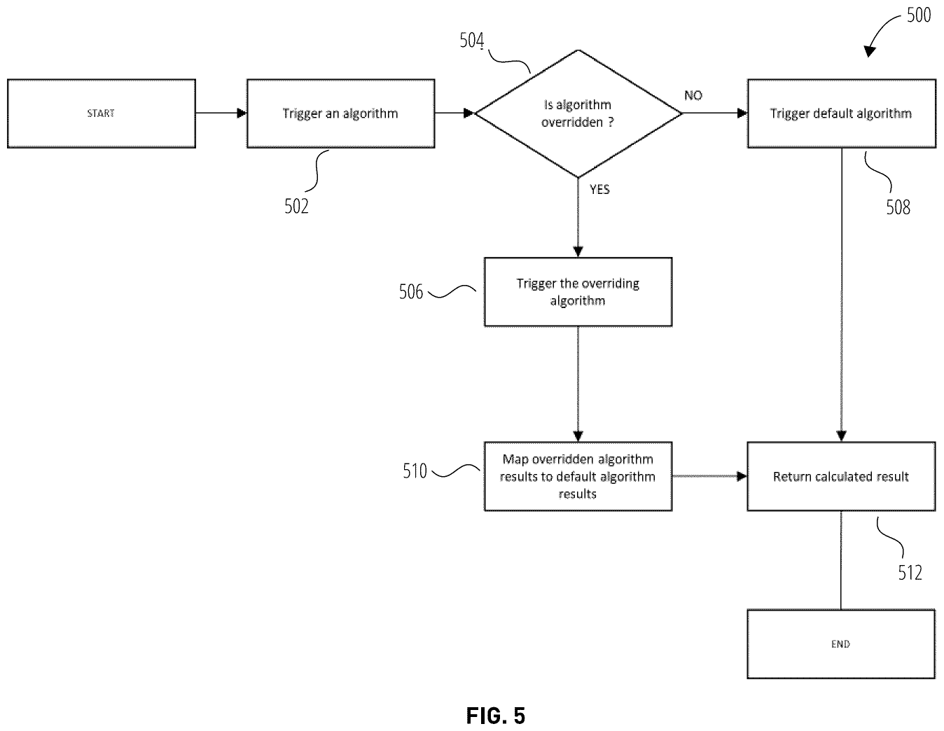

At block 312, upon triggering the default algorithm, the override algorithm is triggered instead. In an embodiment, the override algorithm may be triggered according to the method illustrated in FIG. 5. Triggering the override algorithm causes the override algorithm to be utilized in the computation in place of the default algorithm and returning the return value(s) of the override algorithm to the result node of the default algorithm, such as at, for example, block 206 and block 208 as previously described with reference to FIG. 2.

In some embodiments, override algorithms may be provided, such as, for example, at block 202 of FIG. 2, with a mapping to a default algorithm, including a mapping of the return value(s) of the override algorithm to return value(s) of the default algorithm. In other embodiments, a mapping between the override algorithm and the default algorithm may be performed in order to provide the mapping.

FIG. 4 illustrates a block diagram 400 of an example method for mapping default algorithms overridden by an override algorithm at runtime in accordance with one embodiment. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At block 402, a list of override algorithms is received. Receiving the override algorithms may comprise identifying all of the override algorithms, or a plurality of override algorithms, that have been provided at the database server 104, such as at, for example, block 202 as previously described with reference to FIG. 2. In identifying the override algorithms and/or receiving a list of override algorithms, the list may comprise any data structure such as, for example, a string, a vector, an array, or any other data structure suitable for the configuration.

At block 404, each of the override algorithms in the list is initially flagged as unprocessed.

At decision block 406, a determination of whether there are any override algorithms marked as unprocessed is made.

If the determination at decision block 406 is that no override algorithms are marked as unprocessed (“NO” at decision block 406), then no further action may be taken.

If the determination at decision block 406 is that there are override algorithms marked as unprocessed (“YES” at decision block 406), then the method proceeds to block 408 where an unprocessed override algorithm is selected.

At block 410, the default algorithm that the override algorithm overrides is flagged as overridden.

At block 412, the result fields of the default algorithm are marked as unprocessed. Each of the result fields of the default algorithm correspond to a result node of the default algorithm.

At decision block 414, a determination of whether there are any unprocessed default algorithm fields is made.

If the determination at decision block 414 is that are no unprocessed default algorithm fields (“NO” at decision block 414), then the method proceeds to block 416 where the default algorithm field is marked as processed, and the method returns back to decision block 406.

If the determination at decision block 414 is that there is an unprocessed default algorithm field at decision block 414 (“YES” at decision block 414), then the method proceeds to block 418, and an unprocessed default algorithm field is selected.

At decision block 420, a determination of whether the default field maps to an overridden field is made.

If the determination at decision block 420 is that the default field maps to an overridden field (“YES” at decision block 420), then the method proceeds to block 424 where the default field result is mapped to the overridden field result.

If the determination at decision block 420 is that the default field does not map to an overridden field (“NO” at decision block 420), then at the method proceeds to block 422 where the default field result is set to a static value.

At block 426, after block 424 or block 422, the default algorithm field is marked as processed, and the process returns to decision block 414.

In an embodiment, the static value is one of a numeric value of 0, an empty string, or a time variable corresponding to the Unix Epoch.

FIG. 5 illustrates a block diagram 500 of an example method for triggering an override algorithm in place of a default algorithm at runtime. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

The method illustrated in FIG. 5 may be one example of a method for performing, for example, block 206 of the method described previously with reference to FIG. 2 to utilize an override algorithm in place of a first algorithm.

At block 502, an algorithm is triggered at runtime.

At decision block 504, a determination whether the algorithm is overridden by an override algorithm is made.

If the determination at decision block 504 is that the algorithm is not overridden by an override algorithm (“NO” at decision block 504), then the method proceeds to block 508 where the default algorithm is triggered. Triggering the default algorithm may cause, for example, the default algorithm to be utilized in a computation.

If the determination at decision block 504 is that the algorithm is overridden by an override algorithm (“YES” at decision block 504), then the method proceeds to block 506 where the override algorithm is triggered. Triggering the override algorithm at block 506 may cause, for example, the default algorithm to be utilized in a computation. At block 510 the results of the override algorithm map to the results of the default algorithm.

At block 512, after either block 508 or block 510, the calculated result of either the default algorithm or the override algorithm utilized in the computation, is returned.

In an embodiment, the database server 104 may store the output or return value(s) of the override algorithm in a memory, such as, for example, the memory 108 or disk 110 of the database server 104, or the database 102. The return value(s) stored in memory may be stored in association with a cache. More specifically, storing the return value(s) of the override algorithm in a cache may be performed according to the mapping previously described in reference to FIG. 4. Caching may be used to store data that results from a computation utilizing an algorithm (e.g., a default algorithm or an override algorithm) for subsequent access without having to recompute the result value(s).

Caching may also include invalidation as a countermeasure against infinite scaling of stored data that may reduce the amount of available memory space. Invalidation may also be used in response to other changes at the database server 104, such as, for example, changes in the stored data, the inputs, or the dependencies for a computation, schema, process, algorithm. Caching data, such as outputs and return values, may be used in a variety of circumstances for various reasons or benefits. Triggering invalidation may remove, delete, or replace, or overwrite a cached return value.

During runtime, the invalidation trigger of the overridden default algorithm may be ignored, and the invalidation trigger of the overriding algorithm may be used to remove, delete, or replace the return value of the override algorithm stored in the cache.

The following example embodiment that illustrates how invalidation triggers may be incorporated into the method described previously in reference to FIG. 2.

At block 204, determining a triggering event that causes the first algorithm to be utilized in a computation may comprise determining an invalidation triggering event. The computation may further comprise invalidating a cache.

At block 206, in response to the triggering event, the override algorithm is used in place of the first algorithm in the computation, which may comprise triggering invalidation of the override algorithm.

At block 208, the return value from the override algorithm is stored in the memory location that corresponds to a result node of the first algorithm. The memory location may be associated with the cache, and storing the return value may further comprise performing the invalidation by replacing the previously stored return value of the override algorithm with a new return value of the override algorithm. Invalidation may comprise replacing, removing, or deleting the stored return value in the cache. The new return value may be determined according to any means, including but not limited to changing the inputs of the override algorithm, changing the dependencies of the override algorithm, and/or changing the implementation of the override algorithm.

In an embodiment in which a default algorithm is not overridden, determining whether a default algorithm is overridden and triggering invalidation of the default algorithm may be performed in accordance with the method previously described in reference to FIG. 5. Triggering invalidation of the default algorithm may comprise invalidating the default return value of the default algorithm stored in memory in, for example, a cache.

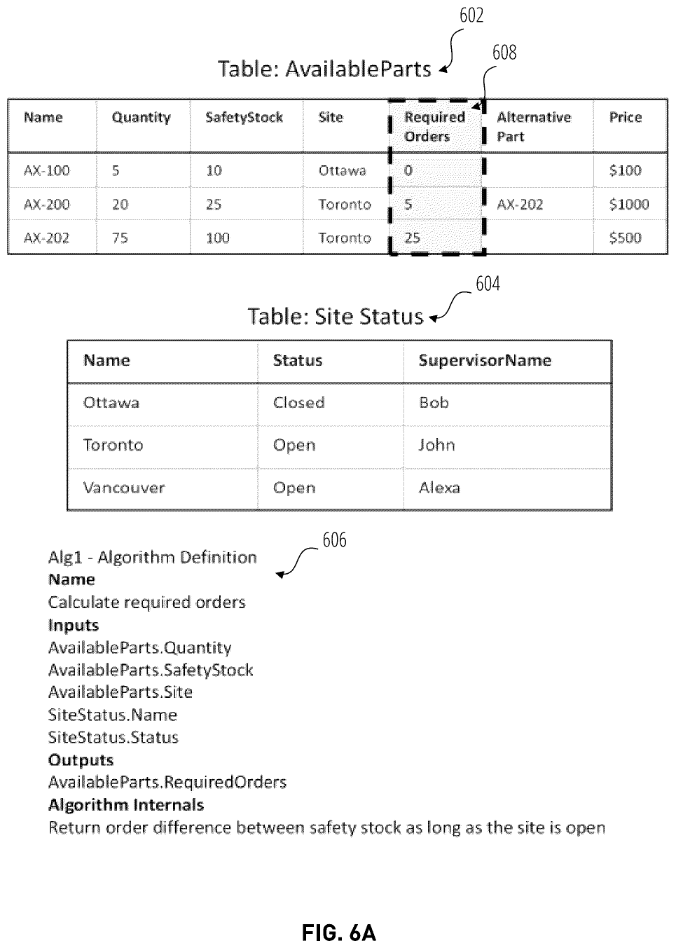

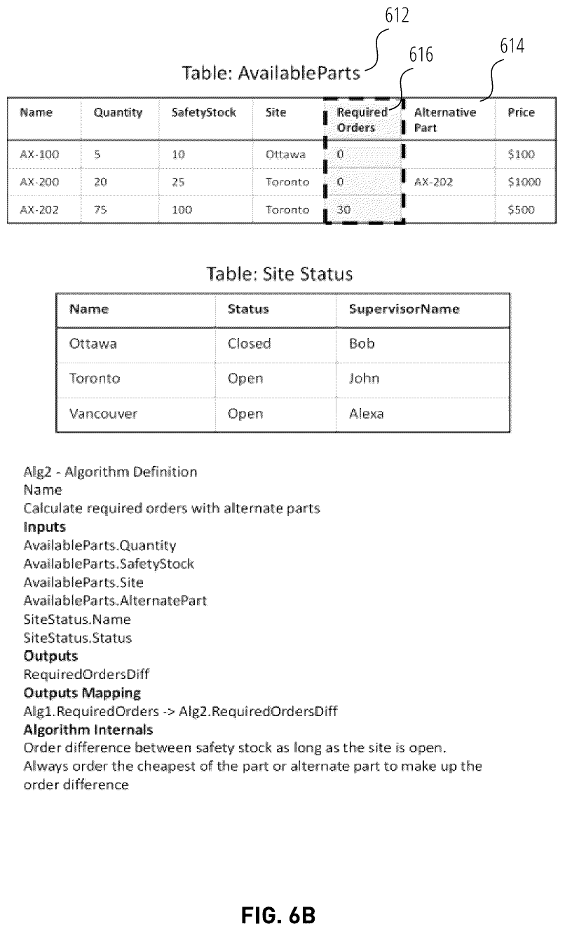

FIG. 6A illustrates an output of a first algorithm, Algorithm 1 (or “Alg1”), and Alg1's input and output fields. In the example illustrated in FIG. 6A, Algorithm 1 is configured to calculate the return order difference between safety stock as long as the site is open. Alg1 is defined at 606 to have inputs or dependencies that correspond to values in the tables “AvailableParts” 602 and “Site Status” 604, which are used to calculate return values, or an output, corresponding to the fields in the “Required Orders” column 608 (shown shaded and outlined by a dashed line in FIG. 6A for emphasis) in the AvailableParts Table 602. As illustrated in FIG. 6A, Alg1 has the following inputs: Quantity, Safety Stock, Site, Name, and Status.

FIG. 6A illustrates the output of a first algorithm, Algorithm 1 (or “Alg1”), and Alg1's input and output fields. In the example illustrated in FIG. 6A, Algorithm 1 is configured to calculate the return order difference between safety stock as long as the site is open. Alg1 is defined at 606 to have inputs or dependencies that correspond to values in the tables “AvailableParts” 602 and “Site Status” 604, which are used to calculate return values, or an output, corresponding to the fields in the “Required Orders” column 608 (shown shaded and outlined by a dashed line in FIG. 6A for emphasis) in the AvailableParts Table 602. As illustrated in FIG. 6A, Alg1 has the following inputs: Quantity, Safety Stock, Site, Name, and Status.

FIG. 6B illustrates an example of the output of an override algorithm, Algorithm 2 (or “Alg2”), that is configured to override Alg1 of FIG. 6A. Alg2 is configured to order the difference between safety stock as long as the site is open, with the additional requirement to always order the cheapest part or alternate part to make up the order difference. Alg2 therefore is configured to have a different input than Alg1. More specifically, Alg2 has the same inputs as Alg1 with the addition of the input of “Alternate Part” 614 stemming from the AvailableParts table 612. Alg2′s output corresponds to the fields in the “Required Orders” column 616 (shown shaded and outlined by a dashed line in FIG. 6B for emphasis) in the AvailableParts Table 612.

In other embodiments, the inputs of the first algorithm and the inputs of the override algorithm may be any combination or permutation of being the same, partially the same, or different. The override algorithm may have a greater, lesser, or equal number of inputs than the default algorithm, or have no inputs at all.

In FIG. 6A, Alg1 is not overridden and calculates an output where the required order for part AX-100 is 0, for part AX-200 is 5, and for part AX-202 is 25. In FIG. 6B, Alg1 is overridden by Alg2 and calculates an output where the required order for part for part AX-100 is 0, for part AX-200 is 0, and for part AX-202 is 30, which considers the additional input to Alg2, namely that part AX-202 is an alternate part for any of parts AX-100, AX-200, and AX-202.

The present disclosure describes systems and methods for overriding the execution of an algorithm at runtime. More specifically, the present disclosure describes systems and methods of overriding a default algorithm, i.e., an algorithm that runs natively to the database, with an override algorithm that may be stored external to the database.

It is desirable to be able to override a default algorithm such that the results of the override algorithm replace the results of a default algorithm that is native (i.e., static) to a database 102. A benefit of this solution is that users or customers can implement specific configurations that meet their unique needs without changing the code of the default algorithm, while also maintaining the performance benefit of using a default algorithm in a database.

FIG. 7 illustrates a block diagram 700 of an example method for defining an override algorithm, in accordance with one embodiment. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At block 702, a user can define a new algorithm (also known as the override algorithm). The new algorithm may comprise code that is stored and executed external to the database server 104. For example, the override algorithm may be executed by an external device that communicates with the database server 104 to receive data from and return data to the database server 104. In other embodiments, the override algorithm may be provided by the database server receiving the override algorithm from an external device, such as a client device (for example, client device 112 and/or client device 114).

At block 704, the user can define one or more dependencies of the new algorithm. Next, at block 706, the use can define the algorithm return values. At block 708, the user can define which algorithm the new algorithm will override. Finally, at block 710, the user can define a mapping between the overridden algorithms results and the new algorithm results.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
providing, by a processor, an override algorithm mapped to a first algorithm to override the first algorithm in a database, the override algorithm configured to provide a return value in a memory location corresponding to a result node of the first algorithm;
receiving, by the processor, a trigger event that causes the first algorithm to be utilized in a computation;
in response to receiving the triggering event, utilizing, by the processor, the override algorithm in place of the first algorithm in the computation; and
storing, by the processor, the return value from the override algorithm in the memory location that corresponds to the result node of the first algorithm.

2. The method of claim 1,
wherein providing the override algorithm comprises:
providing, by the processor, a plurality of override algorithms, each of the plurality of override algorithms mapped to at least one default algorithm in a first plurality of default algorithms that includes the first algorithm; and
wherein utilizing the override algorithm in place of the first algorithm in the computation comprises:
utilizing, by the processor, the override algorithm of the plurality of override algorithms that is mapped to the first algorithm.

3. The method of claim 2, wherein:
providing the override algorithm mapped to the first algorithm further comprises:
mapping, by the processor, the override algorithm to the first algorithm to override the first algorithm in the database: and
wherein mapping the override algorithm to the first algorithm comprises:
identifying, by the processor, in a list the plurality of override algorithms;
flagging, by the processor, the plurality of override algorithms in the list as unprocessed;
determining, by the processor, if any of the plurality of override algorithms in the list is flagged as unprocessed;
selecting, by the processor, an unprocessed override algorithm;
flagging; by the processor, the corresponding at least one default algorithm mapped to the override algorithm as overridden;
flagging, by the processor, the result node of the first algorithm as unprocessed;
determining, by the processor, whether the result node of any of the plurality of default algorithms is flagged as unprocessed;
selecting, by the processor, an unprocessed result node;
determining, by the processor, whether the unprocessed result node from any of the plurality of default algorithms is located in the memory location that corresponds to an override result node of any of the plurality of override algorithms;
in response to determining the unprocessed result node from any of the plurality of default algorithms is located in the memory location that corresponds to the override result node of any of the plurality of override algorithms:
mapping, by the processor, the unprocessed result node to the override result node; and
flagging, by the processor, the unprocessed result node as processed.

4. The method of claim 3, wherein when the unprocessed result node from any of the plurality of default algorithms is not located in the memory location that corresponds to override result node of any of the plurality of override algorithms, the method further comprises:
assigning, by the processor, the unprocessed result node a static value; and
flagging, by the processor, the unprocessed result node as processed.

5. The method of claim 4, wherein the static value is a numeric value of 0, or an empty string, or a time variable of Unix Epoch.

6. The method of claim 2, further comprising:
identifying, by the processor, a second plurality of default algorithms,
wherein the second plurality of default algorithms are not overridden by the plurality of override algorithms; and
storing, by the processor, a default return value from each of the second plurality of default algorithms in the memory location that corresponds to the result node of each of the second plurality of default algorithms.

7. The method of claim 1, wherein the memory location is associated with a cache.

8. The method of claim 7, further comprising:
receiving, by the processor, an invalidation trigger event that invalidates a default return value in the cache; and
in response to receiving the invalidation triggering event:
invalidating, by the processor, a return value of the override algorithm in place of the default return value.

9. A system comprising:
a processor; and
a memory storing instructions that, when executed by the processor, configure the system to:
provide an override algorithm mapped to a first algorithm to override the first algorithm in a database, the override algorithm configured to provide a return value in a memory location corresponding to a result node of the first algorithm;
receive a trigger event that causes the first algorithm to be utilized in a computation;
in response to receiving the triggering event, utilize the override algorithm in place of the first algorithm in the computation; and
store the return value from the override algorithm in the memory location that corresponds to the result node of the first algorithm.

10. The system of claim 9, wherein:
when providing the override algorithm, the instructions that, when executed by the processor, further configure the system to:
provide a plurality of override algorithms, each of the plurality of override algorithms mapped to at least one default algorithm in a first plurality of default algorithms that includes the first algorithm; and
when utilizing the override algorithm in place of the first algorithm in the computation, the instructions that, when executed by the processor, further configure the system to:
utilize the override algorithm of the plurality of override algorithms that is mapped to the first algorithm.

11. The system of claim 10, wherein:
when providing the override algorithm mapped to the first algorithm, the instructions that, when executed by the processor, further configure the system to:
map the override algorithm to the first algorithm to override the first algorithm in the database by configuring the system to:
identify in a list the plurality of override algorithms;
flag the plurality of override algorithms in the list as unprocessed;
determine if any of the plurality of override algorithms in the list is flagged as unprocessed;
select an unprocessed override algorithm;
flag the corresponding at least one default algorithm to the override algorithm as overridden;
flag the result node of the first algorithm as unprocessed;
determine whether the result node of any of the plurality of default algorithms is flagged as unprocessed;
select an unprocessed result node;
determine whether the unprocessed result node from any of the plurality of default algorithms is located in the memory location that corresponds to an override result node of any of the plurality of override algorithms; and
in response to determining the unprocessed result node from any of the plurality of default algorithms is located in the memory location that corresponds to the override result node of any of the plurality of override algorithms, the instructions that, when executed by the processor, further configure the system to:
map the unprocessed result node to the override result node; and
flag the unprocessed result node as processed.

12. The system of claim 11, wherein when the unprocessed result node from any of the plurality of default algorithms is not located in the memory location that corresponds to the override result node of any of the plurality of override algorithms, the instructions that, when executed by the processor, further configure the system to:
assign the unprocessed result node a static value; and
flag the unprocessed result node as processed.

13. The system of claim 12, wherein the static value is a numeric value of 0, or an empty string, or a time variable of Unix Epoch.

14. The system of claim 10, wherein the instructions that, when executed by the processor, further configure the system to:
identify a second plurality of default algorithms, wherein the second plurality of default algorithms are not overridden by the plurality of override algorithms; and
store a default return value from each of the second plurality of default algorithms in the memory location that corresponds to the result node of each of the second plurality of default algorithms.

15. The system of claim 9, wherein the memory location is associated with a cache.

16. The system of claim 15, wherein the instructions that, when executed by the processor, further configure the system to:
receive an invalidation trigger event that invalidates a default return value in the cache; and
in response to receiving the invalidation triggering event, invalidate a return value of the override algorithm in place of the default return value.

17. A non-transitory computer-readable storage medium, the computer-readable storage medium including instructions that when executed by a computer, cause the computer to:
provide an override algorithm mapped to a first algorithm to override the first algorithm in a database, the override algorithm configured to provide a return value in a memory location corresponding to a result node of the first algorithm;
receive a trigger event that causes the first algorithm to be utilized in a computation;
in response to receiving the triggering event, utilize the override algorithm in place of the first algorithm in the computation; and
store the return value from the override algorithm in the memory location that corresponds to the result node of the first algorithm.

18. The non-transitory computer-readable storage medium of claim 17,
when providing the override algorithm, the instructions that, when executed by the computer, further configure the computer to:
provide a plurality of override algorithms, each of the plurality of override algorithms mapped to at least one default algorithm in a first plurality of default algorithms that includes the first algorithm; and
when utilizing the override algorithm in place of the first algorithm in the computation, the instructions that, when executed by the computer, further configure the computer to:
utilize the override algorithm of the plurality of override algorithms that is mapped to the first algorithm.

19. The non-transitory computer-readable storage medium of claim 18, wherein:
when providing the override algorithm mapped to the first algorithm, the instructions that, when executed by the computer, further configure the computer to:
map the override algorithm to the first algorithm to override the first algorithm in the database by configuring the computer to:
identify in a list the plurality of override algorithms;
flag the plurality of override algorithms in the list as unprocessed;
determine if any of the plurality of override algorithms in the list is flagged as unprocessed;
select an unprocessed override algorithm;
flag the corresponding at least one default algorithm to the override algorithm as overridden;
flag the result node of the first algorithm as unprocessed;
determine whether the result node of any of the plurality of default algorithms is flagged as unprocessed;
select an unprocessed result node;
determine whether the unprocessed result node from any of the plurality of default algorithms is located in the memory location that corresponds to an override result node of any of the plurality of override algorithms; and
in response to determining the unprocessed result node from any of the plurality of default algorithms is located in the memory location that corresponds to the override result node of any of the plurality of override algorithms:
map the unprocessed result node to the override result node; and
flag the unprocessed result node as processed.

20. The non-transitory computer-readable storage medium of claim 19, wherein when the unprocessed result node from any of the plurality of default algorithms is not located in the memory location that corresponds to the override result node of any of the plurality of override algorithms, the instructions that, when executed by the computer, further configure the computer to:
assign the unprocessed result node a static value; and
flag the unprocessed result node as processed.

21. The non-transitory computer-readable storage medium of claim 20, wherein the static value is a numeric value of 0, or an empty string, or a time variable of Unix Epoch.

22. The non-transitory computer-readable storage medium of claim 17, the instructions that, when executed by the computer, further configure the computer to:
identify a second plurality of default algorithms, wherein the second plurality of default algorithms are not overridden by the plurality of override algorithms; and
store a default return value from each of the second plurality of default algorithms in the memory location that corresponds to the result node of each of the second plurality of default algorithms.

23. The non-transitory computer-readable storage medium of claim 17, wherein the memory location is associated with a cache.

24. The non-transitory computer-readable storage medium of claim 23, the instructions that, when executed by the computer, further configure the computer to:
receive an invalidation trigger event that invalidates a default return value in the cache; and
in response to receiving the invalidation triggering event, invalidate a return value of the override algorithm in place of the default return value.
